(19) United States
(12) Patent Application Publication
(10) Pub. No.: US 2020/0351109 A1
(43) Pub. Date: Nov. 5, 2020

(54) SYSTEM AND METHOD FOR INVISIBLE CHAT MEMBER REAL-TIME CHAT EVENT PROCESSING

(71) Applicant: Irad DEUTSCH, Bnei Atarot (IL)

(72) Inventors: Irad DEUTSCH, Bnei Atarot (IL); Eliran MALKI, Bnei Atarot (IL)

(21) Appl. No.: 16/759,058

(22) PCT Filed: Oct. 24, 2018
(86) PCT No.: PCT/IL2018/051149

§ 371 Date: Apr. 24, 2020

Related U.S. Application Data
(60) Provisional application No. 62/576,123, filed on Oct. 24, 2017.

(51) Int. Cl. H04L 12/18; H04L 29/08; H04L 12/58; H04L 29/06

(52) U.S. Cl. CPC H04L 12/1822; H04L 65/403; H04L 51/12; H04L 67/26

(57) ABSTRACT

A system and method for generating real-time notification based on events within a chat engine using an invisible chat member for readily capturing a plurality of chat events in at least one chat room and processing the chat events substantially on a real-time basis thereby creating an out-of-chat event.

### FIELD AND BACKGROUND OF THE INVENTION

The present invention is related to online and substantially real-time chat system and method. More particularly, the invention is related to a chatting system and method including a real-time event processing of chat traffic and events for generating at least one out-of-chat event such as a notification, an email, an alert, a user blocking UI event and the like.

The system and method of the present invention is also designed to be retrofitted to existing chatting system thereby readily facilitating a task selected from the group consisting of an alert responsive to specific key words being used for blocking/banning abusive users, a substantially real time Ad-banner change according to a chat topic analysis, creating a substantially real time alert responsive to a chat activity level reaching above and/or below a predefined threshold of throughput rate and an interception of chat responsive to chat traffic analysis and processing.

Chat rooms, including people using many chatting applications such as mobile applications, web chats or any other type of online real-time chat technology systems, are well known in the art.

There are quite a few chat systems available on the market such as PROSODY™ or EJABBERED™. Such chat system known in the art allow users to communicate with each other on a real-time basis including seeing new messages and seeing the partner status (offline, online, is typing and the like).

When such a chat system is part of a greater application or system, it is required to generate events based on conversation events. Most chatting systems available on the market, are closed systems wherein intercepting the chat traffic and generating a real-time event requires change of code, or adding an intrusive component between the user and the chatting system.

It is therefore an object of the present invention to provide a non-intrusive flexible system and method for monitoring chat activity and for readily producing at least one substantially real-time event based on chat traffic by way of registering an invisible user to chat-rooms wherein traffic within a chat-room is delivered to an invisible user as if the invisible user was a “real” user in the chat-room. Data delivered to the invisible user activity is sent and processed by a “Chat Traffic Processing Server” (CTPS) which CTPS appears to other users like a “real” client connected to the chat server.

It is a further object of the present invention to suggest a method in which a new message is received through an invisible user channel while CTPS processes the new message on a substantially real-time basis. Based on a pre-defined set of rules, CTPS readily generates at least one out-of-chat event such selected from the group consisting of a push notification, an alert, a block/ban and an event responsive to chat messages contents and/or chat message characteristics.

Therefore, there is an unmet need for, and it would be highly useful to have, a non-intrusive system and method readily applied to existing chatting system, wherein an invisible machine based user is registered to all chat rooms, intercept all chat traffic, send it to a Chat Traffic Processing Engine, that can produce alerts or trigger events based a pre-defined set of rules or fully automated using machine learning.

### SUMMARY OF THE INVENTION

The present invention is a non-intrusive system and method readily applied to existing chatting system, wherein an invisible machine based user is registered to all chat rooms, intercept all chat traffic, send it to a Chat Traffic Processing Engine, that can produce alerts or trigger events based a pre-defined set of rules or fully automated using machine learning.

At the basic level of the invention, a chat engine of any kind is used. The chat engine is being accessed by an application server, mobile app or any other kind of application. The application is calling the chat server asking to create new chat rooms and register chat members.

Once all members are in a chat room, when a message is being sent by one of the members, the chat server is responsible for distributing the message to all other members in the chat room.

The chat traffic is not accessed from any other source except the using application. Some chat servers can spill to disk the chat traffic for off-line or near-real-time analysis only which is not enough for real-time events that are chat-based, to take place.

The present invention can leverage any existing chatting system allowing real-time processing of chat events by registering an invisible user to the chat room. This invisible user is known to the chat server as a normal user. By doing that, all chat events that are distributed to all chat members are also sent to the invisible user.

The invisible user includes a CTPS (Chat Traffic Processing Server) for monitoring substantially all chat traffic. Preferably, CTPS processes chat traffic on a substantially real-time basis and wherein CTPS is responsive to a triggering event.

According to a preferred embodiment of the present invention, there is provided a chat monitoring system including: a chat server including at least one chat room, at least one first user using a first chat device logged in to the chat server, at least one second user using a second chat device logged in to the chat server, and a Chat Traffic Processing Server monitoring at least one message generated by the first user or the second user.

According to further preferred embodiments of the present invention, the chat monitoring system further includes at least one invisible user receiving messages generated by the first user or the second user.

According to still further embodiments of the present invention, the chat monitoring system further includes at least one chat room.

According to yet further embodiments of the present invention the chat room includes the first user, the second user and at least one invisible user generated by the Chat Traffic Processing Server.

According to additional further embodiments of the present invention the Chat Traffic Processing Server is responsive to the use of a trigger word in the chat room

According to still further embodiments of the present invention, the Chat Traffic Processing Server readily generates at least one out-of-chat event, selected from the group consisting of a push notification, an alert, a block/ban in response to the use of a trigger word in the chat room.

Thus, a standard chatting server can be enhanced and/or retrofitted with a real-time monitoring and event triggering capability.

### BRIEF DESCRIPTION OF THE DRAWINGS

The invention is herein described, by way of example only, with reference to the accompanying drawings, wherein:

FIG. 1 is a general flowchart of the method of present invention portraying an invisible user registration in a chat room, interception of chat traffic, and sending chat traffic to the CTPS for processing;

FIG. 2 is a general flowchart of the algorithm of chat room establishment and the registration of the invisible user; and

FIG. 3. is a general flowchart of the algorithm of the CTPS showing data traffic being processed substantially subsequently to being intercepted by the invisible user.

### DESCRIPTION OF THE PREFERRED EMBODIMENTS

The present invention is related to online and substantially real-time chat system and method. More particularly, the invention is related to a chatting system and method including a real-time event processing of chat traffic and events for generating at least one out-of-chat event such as a notification, an email, an alert, a user blocking UI event and the like.

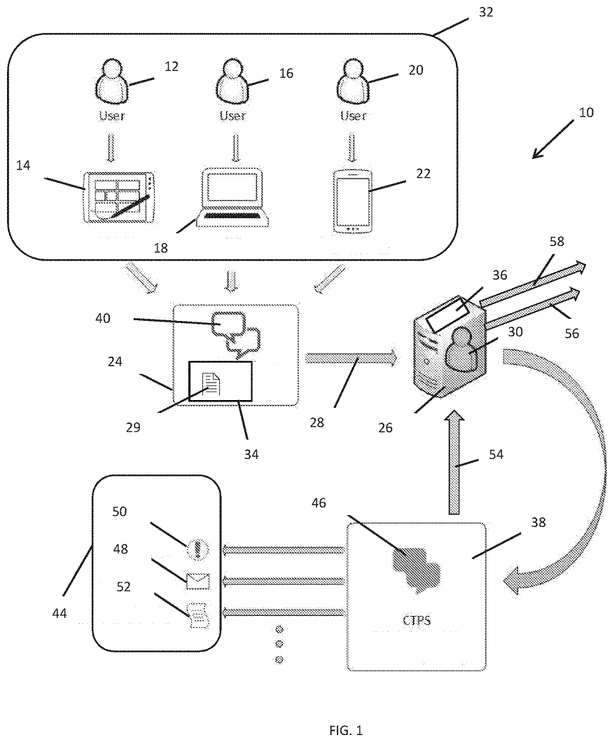

Referring now to the drawings, FIG. 1 shows a schematic view of a first embodiment of a chatting system 10 modified to monitor and analyze a chat room including a plurality of users. As shown in FIG. 1 and by way of an non-limiting example only, a first user 12 preferably uses a first chat device 14 wherein first chat device 14 includes chat enabling hardware and software, a second user 16 preferably uses a second chat device 18 wherein second chat device 18 includes chat enabling hardware and software and a third user 20 preferably uses a third chat device 22 wherein third chat device 22 includes chat enabling hardware and software.

Preferably, at least one chat device selected from the group consisting of first chat device 14, second chat device 18 and third chat device 22 includes a computer.

Preferably, at least one chat device selected from the group consisting of first chat device 14, second chat device 18 and third chat device 22 includes a portable communication device or PDA.

Preferably and as shown, a plurality of chat devices are connected to at least one chat room 24 operated by a chat server 26 for the purpose of generating an alert 28 to a supervisor 30 of a plurality of users 32 using at least one trigger word 34 being used in chat room 24.

Preferably, plurality of users 32 includes at least one of first user 12 second user 16 and third user 20 and/or other participants using chat room 24.

Preferably, a new alert 28 is generated and sent to supervisor 30 occasioning on a chat message 29 containing at least one trigger word 34 selected from the group consisting of at least one predetermined trigger word list 36 being used in at least one chat-room 24.

Preferably, trigger word list 36 includes words selected from a group consisting of at least one abusive trigger word, at least one danger indicative trigger word, at least one obscenity trigger word and at least one general alert trigger word.

The term “trigger word” as used herein shall include but will not be limited to actual words written, words spoken, images and NLP events including sentiment, Timex and the like.

The term “danger indicative word” as used herein shall include but will not be limited to words are indicative of the user presenting a degree of danger to himself or to third parties, wherein the degree of danger threshold is readily set by supervisor 30.

The term “Supervisor” as used herein, shall include but will not be limited to a parent, a guardian, a corrections officer monitoring suspects and/or prisoners, a school teacher monitoring students, a dedicated server hardware, a dedicated server software and/or application, a security and/or law enforcement and/or military body monitoring and/or intercepting suspected chat activity and the like.

Preferably, chatting system 10 is attached to, or integrally formed with a Chat Traffic Processing Server” (CTPS) 38 for monitoring substantially all chat traffic in at least one chat room 24. Preferably, CTPS 38 processes chat traffic on a substantially real-time basis and wherein CTPS 38 is responsive to a triggering event.

Preferably, CTPS 38 is a dedicated server geared towards readily monitoring chat traffic.

Optionally, a standard chatting server can be enhanced and/or retrofitted with a real-time chat monitoring system 10 of the present invention responsive to an event and/or triggering alert.

Preferably, CTPS 38 is non-intrusive when monitoring chat activity and CTPS 38 produces at least one substantially real-time event based on chat traffic by way of CTPS 38 registering an invisible user 40 to chat room 24.

Preferably, traffic within chat room 24 is delivered to invisible user 40 as if invisible user 40 was a “real” user selected from plurality of users 32 which plurality of users 32 includes at least one of first user 12 second user 16 and third user 20 and/or other “real” participants using chat room 24.

Substantially thereafter, chat activity is sent and processed by CTPS 38 to invisible user 40.

Preferably, CTPS 38 appears to plurality of users 32 like a “real” client/user connected to the chat server 26.

Preferably, substantially every new chat message 29 in the chat room 24 is delivered to invisible user 40 through an invisible user channel 42 while CTPS 38 processes new chat message 29 on a substantially real-time basis.

Preferably, CTPS 38 readily generates at least one out-of-chat event 44, based on a pre-defined set of rules 46, selected from the group consisting of a push notification 48, an alert 50, a block/ban 52 and an event responsive to contents of chat messages 29 and/or characteristics of chat message 29.

By way of example only and as shown in FIG. 1, chat room 24 is opened in chat server 26. Chat server supervisor 30 of chat server 26 for readily monitoring chat traffic 10.

Optionally, supervisor 30 may elect to remove at least one of group of users 32 in real-time, responsively to identifying the use of trigger word 34 or manually or for any other reason supervisor 30 deems fit to remove.

Optionally, supervisor 30 has no ability or does not want to change the code of chat server 26 to perform this task.

Preferably, CTPS 38 is registered at chat server 26 as an independent user.

Preferably, invisible user 40 is registered to all existing chat rooms 24, as well as to any other new chat rooms 24 that is created.

By way of example only, occasioning on at least one of group of users 32 chatting in chat room 24, all chat messages 29 are also visible to invisible user 40 in real-time, such that chat messages 29 are received at CTPS 38.

Preferably, CTPS 38 processes all chat messages 29 looking for abusive words. Occasioning on CTPS 38 identifying that at least one user of group of users 32 has used at least one trigger word 34, CTPS 38 sends a command 54 to chat server 26 thereby bringing about an action selected from group consisting of removing the user using trigger word 34, sending an alert to supervisor 30 that trigger word 34 has been used in chat room 24, sending a report 56 and or an alert 58 pertaining to the time, nature, context, identifying Humint or Comint of the user using trigger word 34 or details of the at least one of the other users in chat room 24, with regard to trigger word 34 being used in chat message 29.

Preferably, chat monitoring system 10 monitors and analyzes chat traffic in chat rooms 24 for the purpose of generating an out of chat event 44 to supervisor 30 supervising group of users 32 occasioning on at least one trigger word 34 being used in chat room 24 which at least one user of group of users 32 is logged into.

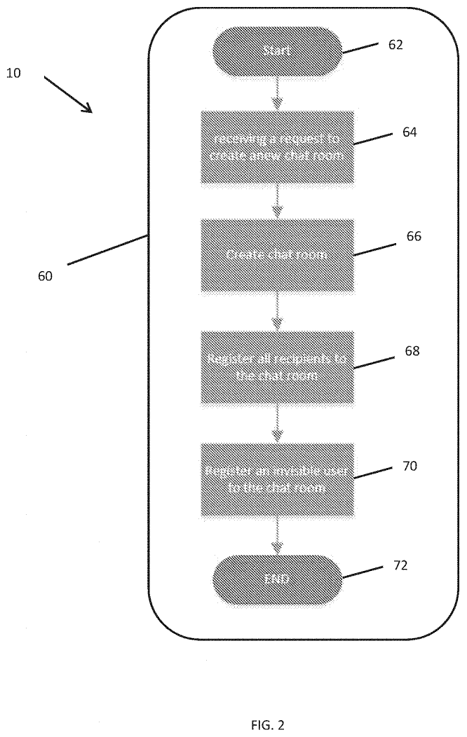

As shown in FIG. 2, a exemplary method of using chat monitoring system 10 is shown. Upon initiating a registration module 60 of chat monitoring system 10 at a start step 62, chat monitoring system 10 becomes responsive to receiving a request to create a new chat room 64.

Substantially thereafter, chat monitoring system 10 creates a chat room at step 66.

Preferably, chat monitoring system 10 registers all participants of the chat room at step 68.

Preferably and substantially contemporaneously, chat monitoring system 10 registers an invisible user to the chat room at step 70 and concludes the initial opening and registering at step 72.

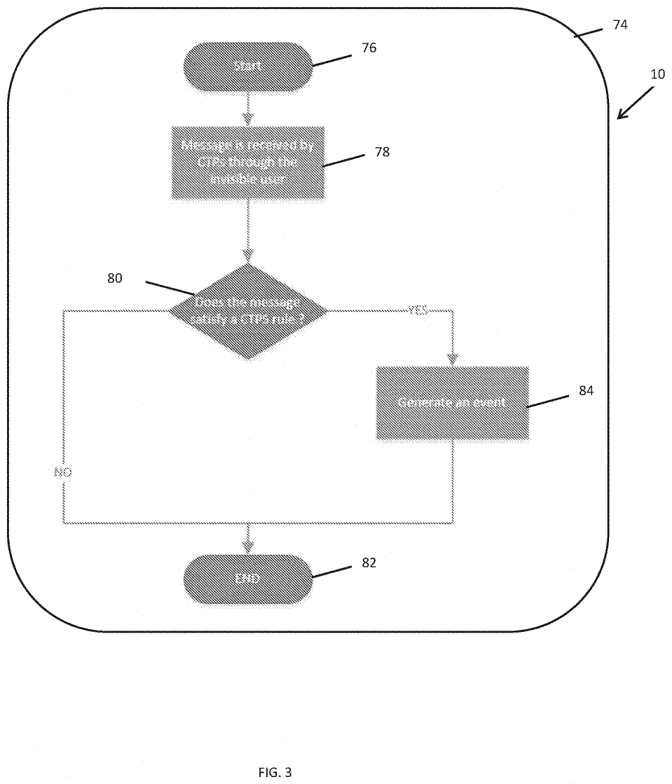

As shown in FIG. 3, upon initiating a message monitoring module 74 of chat monitoring system 10 at a start step 76, a Chat Traffic Processing Server receives a message through an invisible user established by chat monitoring system 10 at a step 78.

Substantially thereafter, at a step 80, Chat Traffic Processing Server analyzes whether the message received meets at least one predetermined criteria defined by chat monitoring system 10.

Occasioning on no criteria being met by the message, chat monitoring system 10 concludes message monitoring module at a step 82.

Alternatively, occasioning on at least one predetermined criteria defined by chat monitoring system 10 being met by the message, chat monitoring system 10 generates an event at a step 84 and thereafter concludes message monitoring module at step 82.

While the invention has been described with respect to a limited number of embodiments, it will be appreciated that many variations, modifications and other applications of the invention may be made.

What is claimed is:

1. A chat monitoring system comprising:
(a) a chat server including at least one chat room;
(b) at least one first user using a first chat device logged in to said chat server;
(c) at least one second user using a second chat device logged in to said chat server; and
(d) a Chat Traffic Processing Server monitoring at least one message generated by said first user or said second user.

2. The chat monitoring system of claim 1, further comprising at least one invisible user receiving messages generated by said first user or said second user.

3. The chat monitoring system of claim 1, wherein said chat monitoring system further includes at least one chat room.

4. The chat monitoring system of claim 3, wherein said chat room includes said first user, said second user and at least one invisible user generated by said Chat Traffic Processing Server.

5. The chat monitoring system of claim 4, wherein said Chat Traffic Processing Server is responsive to the use of a trigger word in said chat room.

6. The chat monitoring system of claim 4, wherein said Chat Traffic Processing Server readily generates at least one out-of-chat event, selected from the group consisting of a push notification, an alert, a block/ban in response to the use of a trigger word in said chat room.
